(19) United States
(12) Patent Application Publication
(10) Pub. No.: US 2024/0048568 A1
(43) Pub. Date: Feb. 8, 2024

(54) THREAT INTELLIGENCE AND LOG DATA ANALYSIS ACROSS CLUSTERED DEVICES

(71) Applicant: Lenovo Enterprise Solutions (Singapore) Pte. Ltd., New Tech Park (SG)

(72) Inventors: Pierre Mouallem, High Point, NC (US); William Laurence Jaeger, Pittsboro, NC (US); Scott A. Piper, Kirkland, WA (US); Michael Gerard Demeter, Roswell, GA (US)

(21) Appl. No.: 17/880,391

(22) Filed: Aug. 3, 2022

(51) Int. Cl. H04L 9/40

(52) U.S. Cl. CPC H04L 63/1416

(57) ABSTRACT

A method for threat intelligence in a peer group includes identifying, at a first node in a network, a potential security threat. The first node is one of a plurality of nodes in a peer group and each node in the peer group has a level of trust for each node in the peer group. The method includes receiving a security communication from one or more other nodes of the peer group. Each security communication indicates that the node of the peer group sending the security communication has identified a potential security threat similar to the potential security threat identified by the first node. The method includes taking a corrective action to neutralize the potential security threat in response to reaching a consensus with the other nodes of the peer group that sent a security communication regarding the identified potential security threats that are similar.

### FIELD

The subject matter disclosed herein relates to threat intelligence for network connected devices and more particularly relates to threat intelligence and log data analysis across clustered devices.

### BACKGROUND

The process of using a central authority for threat intelligence or log data analysis is complex and time consuming, especially in large environments, which can be detrimental to the threat intelligence or log data analysis if that information doesn't trickle back in time to the participating devices (e.g. firewalls, intrusion detection systems, intrusion prevention systems, servers), thus allowing potential attacks or adverse events to negatively impact the performance of the devices. Furthermore, since the process relies on a central authority, it introduces a single point of failure or weakness, and would be an excellent target for attackers, since compromising that central authority would lead to the compromise of the entire system.

### BRIEF SUMMARY

A method for threat intelligence and log data analysis across clustered devices is disclosed. An apparatus and computer program product also perform the functions of the method. The method includes identifying, at a first node in a network, a potential security threat. The first node is one of a plurality of nodes in a peer group and each node in the peer group has a level of trust for each node in the peer group. The method includes receiving, at the first node, a security communication from one or more other nodes of the peer group. Each security communication indicates that the node of the peer group sending the security communication has identified a potential security threat similar to the potential security threat identified by the first node. The method includes taking a corrective action to neutralize the potential security threat in response to reaching a consensus with the other nodes of the peer group that sent a security communication regarding the identified potential security threats that are similar.

An apparatus for threat intelligence and log data analysis across clustered devices includes a processor and non-transitory computer readable storage media storing code. The code is executable by the processor to perform operations that include identifying, at a first node in a network, a potential security threat. The first node includes one of a plurality of nodes in a peer group and each node in the peer group has a level of trust for each node in the peer group. The operations include receiving, at the first node, a security communication from one or more other nodes of the peer group. Each security communication indicates that the node of the peer group sending the security communication has identified a security threat potential security threat similar to the potential security threat identified by the first node. The operations include taking a corrective action to neutralize the potential security threat in response to reaching a consensus with the other nodes of the peer group that sent a security communication regarding the identified potential security threats that are similar.

A program product for threat intelligence and log data analysis across clustered devices includes a non-transitory computer readable storage medium storing code. The code is configured to be executable by a processor to perform operations that include identifying, at a first node in a network, a potential security threat, the first node is one of a plurality of nodes in a peer group and each node in the peer group has a level of trust for each node in the peer group. The operations include receiving, at the first node, a security communication from one or more other nodes of the peer group. Each security communication indicates that the node of the peer group sending the security communication has identified a potential security threat similar to the potential security threat identified by the first node. The operations include taking a corrective action to neutralize the potential security threat in response to reaching a consensus with the other nodes of the peer group that sent a security communication regarding the identified potential security threats that are similar.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a schematic block diagram illustrating a system for threat intelligence and log data analysis across clustered devices on a private network, according to various embodiments;

FIG. 1B is a schematic block diagram illustrating a system for threat intelligence and log data analysis across clustered devices connected using a public network, according to various embodiments;

FIG. 2 is a schematic block diagram illustrating an apparatus for threat intelligence and log data analysis across clustered devices, according to various embodiments;

FIG. 3 is a schematic block diagram illustrating another apparatus for threat intelligence and log data analysis across clustered devices, according to various embodiments;

FIG. 4 is a schematic flow chart diagram illustrating a method for threat intelligence and log data analysis across clustered devices, according to various embodiments;

FIG. 5 is a schematic flow chart diagram illustrating another method for threat intelligence and log data analysis across clustered devices, according to various embodiments; and

FIG. 6 is a schematic flow chart diagram illustrating another method for analyzing threat intelligence and log data analysis across clustered devices using machine learning, according to various embodiments.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or “Flash memory”), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

A method for threat intelligence and log data analysis across clustered devices is disclosed. An apparatus and computer program product also perform the functions of the method. The method includes identifying, at a first node in a network, a potential security threat. The first node is one of a plurality of nodes in a peer group and each node in the peer group has a level of trust for each node in the peer group. The method includes receiving, at the first node, a security communication from one or more other nodes of the peer group. Each security communication indicates that the node of the peer group sending the security communication has identified a potential security threat similar to the potential security threat identified by the first node. The method includes taking a corrective action to neutralize the potential security threat in response to reaching a consensus with the other nodes of the peer group that sent a security communication regarding the identified potential security threats that are similar.

In some embodiments, the first node includes examples of normal operations and examples of operations indicative of a security threat and identifying the potential security threat includes determining that operations at the first node resemble operations indicative of a potential security threat. In further embodiments, the potential security threat differs from the examples of normal operations. In other embodiments, determining that the operations include a potential security threat includes using machine learning seeded with the examples of normal operations and examples of operations indicative of a security threat and/or additional learning based on previous operations to determine that the operations comprise a potential security threat.

In some embodiments, reaching a consensus with the other nodes of the peer group that sent a security communication regarding the identified potential security threats that are similar includes determining that a number of the nodes of the peer group that have identified the similar potential security threats exceeds a threat threshold. In further embodiments, the threat threshold is dynamic and changes based on a type for the potential security threat, a number of nodes in the peer group that have identified a potential security threat that is similar to the potential security threat identified by the first node, a seriousness of the potential security threat, and/or timing of receipt of the potential security threat by the nodes of the peer group. In other embodiments, the method includes transmitting a security communication from the first node to each of the other nodes of the peer group. The security communication indicates that the first node identified the potential security threat.

In some embodiments, each node of the peer group shares with each node of the peer group security communications relevant to determining potential security threats present at the node and/or security communications relevant to determining that potential security threats are not present at the node. In other embodiments, the method includes transmitting, from the first node, the corrective action to neutralize the potential security threat to the other nodes of the peer group. In further embodiments, the other nodes in the peer group that have identified a potential security threat similar to the potential security threat identified by the first node take the corrective action received from the first node.

In some embodiments, the method includes receiving, at the first node, potential corrective actions from other nodes of the peer group, and reaching a consensus with the other nodes of the peer group on a consensus corrective action to be taken by the first node and the other nodes of the peer group. Taking corrective action at the first node includes taking corrective action based on the consensus corrective action. In other embodiments, identifying a potential security threat includes identifying a potential security threat from received network communications, identifying a local authentication failure, identifying local malicious event patterns, and/or identifying indicators of a ransomware attack.

An apparatus for threat intelligence and log data analysis across clustered devices includes a processor and non-transitory computer readable storage media storing code. The code is executable by the processor to perform operations that include identifying, at a first node in a network, a potential security threat. The first node includes one of a plurality of nodes in a peer group and each node in the peer group has a level of trust for each node in the peer group. The operations include receiving, at the first node, a security communication from one or more other nodes of the peer group. Each security communication indicates that the node of the peer group sending the security communication has identified a security threat potential security threat similar to the potential security threat identified by the first node. The operations include taking a corrective action to neutralize the potential security threat in response to reaching a consensus with the other nodes of the peer group that sent a security communication regarding the identified potential security threats that are similar.

In some embodiments, the first node includes examples of normal operations and examples of operations indicative of a security threat and identifying the potential security threat includes determining that operations at the first node resemble operations indicative of a potential security threat. In other embodiments, determining that the operations include a potential security threat includes using machine learning seeded with the examples of normal operations and examples of operations indicative of a security threat and/or additional learning based on previous operations to determine that the operations comprise a potential security threat.

In some embodiments, reaching a consensus with the other nodes of the peer group that sent a security communication regarding the identified potential security threats that are similar includes determining that a number of the nodes of the peer group that have identified the similar potential security threats exceeds a threat threshold. In other embodiments, the threat threshold is dynamic and changes based on a type for the potential security threat, a number of nodes in the peer group that have identified a potential security threat that is similar to the potential security threat identified by the first node, a seriousness of the potential security threat, and/or timing of receipt of the potential security threat by the nodes of the peer group.

In other embodiments, each node of the peer group shares with each node of the peer group security communications relevant to determining potential security threats present at the node, security communications relevant to determining that potential security threats are not present at the node, and/or potential corrective actions, and the operations include transmitting, from the first node, the corrective action to neutralize the potential security threat to the other nodes of the peer group, where the other nodes in the peer group that have identified a potential security threat similar to the potential security threat identified by the first node take the corrective action received from the first node, and/or the operations include reaching a consensus with the other nodes of the peer group on a consensus corrective action to be taken by the first node and the other nodes of the peer group, where taking corrective action at the first node includes taking corrective action based on the consensus corrective action.

A program product for threat intelligence and log data analysis across clustered devices includes a non-transitory computer readable storage medium storing code. The code is configured to be executable by a processor to perform operations that include identifying, at a first node in a network, a potential security threat, the first node is one of a plurality of nodes in a peer group and each node in the peer group has a level of trust for each node in the peer group. The operations include receiving, at the first node, a security communication from one or more other nodes of the peer group. Each security communication indicates that the node of the peer group sending the security communication has identified a potential security threat similar to the potential security threat identified by the first node. The operations include taking a corrective action to neutralize the potential security threat at the first node in response to reaching a consensus with the other nodes of the peer group that sent a security communication regarding the identified potential security threats that are similar.

In some embodiments, the operations include transmitting a security communication from the first node to each of the other nodes of the peer group, where the security communication indicate that the first node identified the potential security threat, and transmitting, from the first node, the corrective action to neutralize the potential security threat to the other nodes of the peer group.

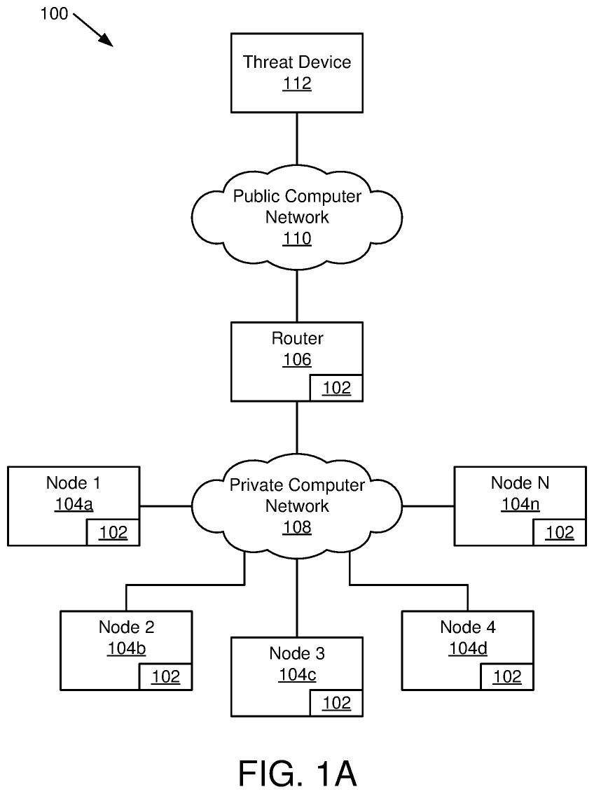

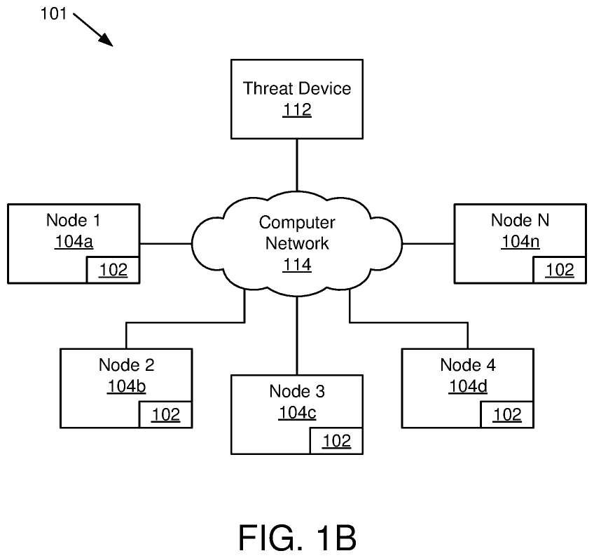

FIG. 1A is a schematic block diagram illustrating a system for threat intelligence and log data analysis across clustered devices 104a-104n, 106 on a private computer network 108, according to various embodiments. The system 100 includes a threat detection and response apparatus 102 in various devices in a peer group, including nodes 1 to N 104a-104n (collectively or generically “104”) and a router 106, which are all connected via a private computer network 108. The router 106 is connected to a threat device 112 over a public computer network 110.

The threat detection and response apparatus 102 provides a way for devices 104, 106 in a peer group to communicate threat information and to take corrective action based on the peer group reaching a consensus regarding the threat communicated in the threat information. Typical threat detection systems use a central authority that collects information, and the central authority alone decides what is a threat and what to do about a threat. However, the central authority may be connected to thousands or millions of devices and so determination of what is a threat often takes too much time. Local devices seeing a threat, such as a ransomware attack, may be compromised long before the central authority acts.

For the embodiments described herein, instead of relying on a central authority for threat intelligence and log data analysis, neighboring devices are grouped into clusters where threat information and log data is shared and aggregated among themselves within the cluster. The threat information is analyzed by the collective via a consensus algorithm that allows the participating devices to coordinate and implement corrective actions in a distributed setting to mitigate threats and improve security, performance, error handling, etc. This process, in some embodiments, adopts a distributed zero trust model which is faster than using a central entity, therefore eliminating the need/reliance on a central authority.

For example, in a cluster of Heuristic-based Network Intrusion Detection and Prevention System (“HIDPS”), an attack pattern detected by one HIDPS can be shared to allow the remaining HIDPSs in the cluster to adapt their threat information to respond to this attack. The response method would vary if that attack pattern is detected across multiple HIDPSs in the cluster. As another example, in a cluster of servers running ransomware detection

and prevention systems (“RDPS”), if one RDPS detects a ransomware attack, it would notify other servers within the cluster so that the other servers in the cluster can better mitigate the incoming ransomware attack.

A cluster of devices, depicted as nodes 104 and a router 106 in the system of FIG. 1A, are devices that have some trust relationship with each other. In the system 100 of FIG. 1A, the nodes 104 and router 106 are connected via a private computer network 108 (or “private network 108”) and may be in a same household, building, owned by a same company or other commonality that enables the nodes 104 and router 106 to be grouped in a cluster.

A cluster of devices may also be referred to as a peer group. Typically, a peer group is a group within a peer-to-peer networking environment where devices in the peer group communicate with each other and no one server, controller, or other device that is in charge of the other devices. In the embodiments described herein, a peer group is used in the sense of communication between threat detection and response 102 in the nodes 104 and router 106 that form a peer group where in other operations a particular node (e.g., 104a) may control one or more of the other nodes (e.g., 104b-104n) and/or router 106. For example, the first node 104a may be a server with management functions while other nodes 104b-104n may be servers without management functions or serve as a backup, may be clients, may be printers, etc. Thus, the term “peer group,” as used herein is applicable to the threat detection and response apparatus 102.

While each node 104 and the router 106 of the system 100 of FIG. 1A have a threat detection and response apparatus 102, other embodiments include devices on the private network 108 without a threat detection and response apparatus 102. In other embodiments, the system 100 includes one or more other routers 106 connected to the public network 110 or to other private networks. In some embodiments, devices with a threat detection and response apparatus 102 control or are gateways for other devices that do not include the threat detection and response apparatus 102 and are protected by the device with the threat detection and response apparatus 102.

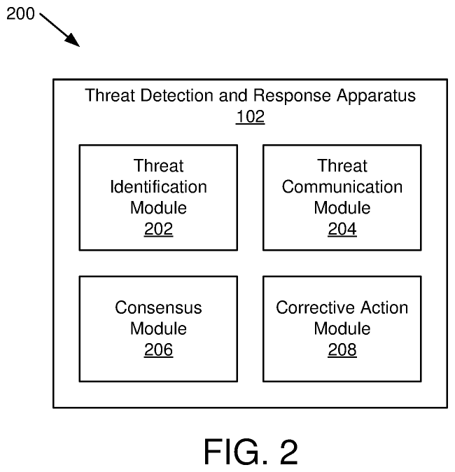

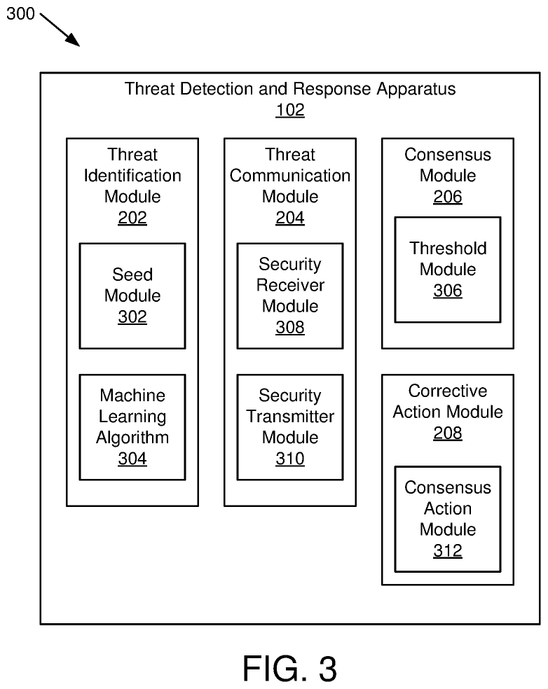

In some embodiments, the threat detection and response apparatus 102, at a first node (e.g., node 1 104a) identifies a potential security threat and also receives a security communication from one or more the other nodes 104b-104n, 106 where each security communication indicates that the node sending the security communication has identified a potential security threat similar to the potential security threat identified by the first node 104a. In response to the first node reaching a consensus with the other nodes of the peer group that sent a security communication regarding the identified potential security threats that are similar, the first node 104a takes corrective action to neutralize the potential security threat. The threat detection and response apparatus 102 is described in more detail with regard to the apparatuses 200, 300 of FIGS. 2 and 3.

A node 104, in various embodiments, may be a desktop computer, a laptop computer, a tablet computer, a smartphone, a workstation, a mainframe computer, a server, a rack-mounted computer, a network controller, or the like. In other embodiments, a node 104 may include a printer, a scanner, a switch, a television, an Internet of Things (“TOT”) device, a device with a processor and network communications, or the like. A node 104 may be embodied by any computing device capable of running a threat detection and response apparatus 102.

The router 106 connects the private network 108 to the public computer network 110 (or “public network 110”), which includes the Internet. In some embodiments, the router 106 provides access to the Internet to the nodes 104 of the private network 108. The router 106, in some embodiments, is a gateway between the public network 110 and the associated internet protocol (“IP”) address space of the public network 110 and the private network 108 and the address space of the private network 108. In some embodiments, the private network 108 is an Open Systems Interconnection (“OSI”) model layer 2 network where network traffic over the private network 108 operates using media access control (“MAC”) addresses of the nodes 104 and router 106. In the embodiment, the nodes 104 may be directly connected to ports of the router or may be connected via a switch or hub, which connects to the router 106. In other embodiments, the private network is an OSI model layer 3 network where the nodes 104 and router 106 communicate using IP addresses. While the router 106 is labeled a router in FIG. 1A for convenience in showing the functionality of the router 106, in various embodiments described herein the router may be referred to as a node 104 and may include a threat detection and response apparatus 102 as with the other nodes 104.

The system 100 includes a threat device 112 that communicates with the router 106 and/or one or more of the nodes 104 and poses a security threat. In some examples, the threat device 112 is a device of a computer hacker that is seeking access to information stored on the private network 108. In other embodiments, the threat device 112 is used to launch a ransomware attack. A ransomware attack is when the threat device 112 is able to access a device and encrypts information so that the information is inaccessible to the rightful owners of the information, which may include sensitive information, and then wants something of value, such as a large sum of money, in exchange for decrypting the information so that the owners of the information can access the information again. In addition, a ransomware attacker may seek money to avoid the attacker from publishing sensitive information accessed by the attacker.

In other embodiments, the threat device 112 is used in a phishing scheme where an attacker sends a fraudulent communication designed to trick a recipient into revealing sensitive information to the attacker or to deploy malicious software on the victim's infrastructure, like a virus, malware, ransomware, etc. In other embodiments, the threat device 112 is used to attempt to login to a node 104 or the router 106 to gain access to proprietary information, to use resources of the accessed device, or the like. In other embodiments, the threat device 112 is used in a User Principle Name access attack or similar scheme to access email addresses or other resources associated with a domain name associated with nodes 104 of the private network 108. In other embodiments, the threat device 112 may be one of several devices involved in a denial-of-service attack, which seeks to disrupt the private network 108 or to disrupt communications from the private network 108. One of skill in the art will recognize other ways that the threat device 112 may be used in a malicious way against nodes 104 and/or the router 106.

The private network 108 and the public network 110 may include a wired network, a fiber network, a wireless connection, etc. and may include a combination of networks. The private network 108 and/or the public network 110 may include a LAN, a WAN, a metropolitan area network (“MAN”), or the like. While the private network 108 may include a hub or switch and may operate at the layer 2 or layer 3 level, typically the public network 110 operates at the layer 3 level using IP addresses.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM”®), the DASH7™ Alliance, and EPCGlobal™

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT-F® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication, such as 4G, Long Term Evolution (“LTE”), or 5G cellular communications. All standards and/or connection types include the latest version and revision of the standard and/or connection type as of the filing date of this application.

FIG. 1B is a schematic block diagram illustrating a system 101 for threat intelligence and log data analysis across clustered devices connected using a public network and/or IP network, according to various embodiments. The system 101 includes a threat detection and response apparatus 102 in various nodes 104a-104n (collectively or generically “104”), a threat device 112, and a computer network 114, which are described below.

The computer network 114 includes a public portion may also include one or more private networks. In some embodiments, at least some of the nodes 104 are connected over a public portion of the computer network 114. In other embodiments, the threat device 112 is connected to the private network 108. For example, an employee may bring a laptop computer (e.g., a node 104) in to work and connect the infected laptop into the private network 108. The threat device 112 communicates with one or more of the nodes 104 at least in part over a public network. In some examples, the computer network 114 includes a LAN or other local network where one or more nodes 104 are connected to the local network portion of computer network 114 and the local network is connected to a public network.

An example of nodes 104 of the system 101 of FIG. 1A are virtual private network (“VPN”) concentrators located in various places around the world. Each VPN concentrator may be connected to a LAN, which connects to a public network or directly to the public network. A threat device 112 may attempt to access nodes 104 that are attempting to communicate with another node 104 through a VPN, which is routed through a VPN concentrator with the threat detection and response apparatus 102. The threat detection and response apparatus 102 on a VPN concentrators may detect a potential security threat and may communicate with other VPN concentrators to determine if the other VPN concentrators are seeing the same or similar potential security threat.

The nodes 104 of the system 101 of FIG. 1B are substantially similar to the nodes 104 and router 106 of the system 100 of FIG. 1A. In addition, the threat device 112 may also be used by hackers in similar ways as described above with regard to the system 100 of FIG. 1A.

FIG. 2 is a schematic block diagram illustrating an apparatus 200 for threat intelligence and log data analysis across clustered devices, according to various embodiments. The apparatus 200 includes a threat detection and response apparatus 102 with a threat identification module 202, a threat communication module 204, a consensus module 206, and a corrective action module 208, which are described below. In some embodiments, the apparatus 200 is implemented with code stored on one or more computer readable storage media and the code is executable by a processor, which may be in a server, a desktop computer, etc. In other embodiments, the apparatus 200 is implemented with a programmable hardware device, such as an FPGA, a programmable logic array (“PAL”), etc., which may be in a router 106, etc. In some embodiments, a portion of the apparatus 200 may be implemented with hardware circuits.

The apparatus 200 includes a threat identification module 202 configured to identify, at a first node in a network (e.g., 104a), a potential security threat. The first node 104a is one of a plurality of nodes 104b-104n in a peer group. Each node 104 in the peer group has a level of trust for each node 104 in the peer group. For example, each node 104 may be owned, controlled, etc. by a single organization, may be connected to a same private network 108, etc. In some embodiments, deployment of threat detection and response apparatuses 102 includes creating a peer group. For example, each node 104 in the peer group may include a list of other nodes 104 in the peer group. In some embodiments, creation of the peer group includes conveying a level of trust for the nodes 104 in the peer group. In some embodiments, the threat detection and response apparatuses 102 of the nodes 104 in the peer group exchange information in a secure way due to the level of trust between nodes 104 of the peer group. One of skill in the art will recognize other ways of establishing a level of trust between nodes 104 of a peer group.

In some embodiments, the threat identification module 202 identifies a potential security threat based on analysis of communications from a device external to the nodes 104 of the peer group. For example, the threat identification module 202 may detect unusual communications from a geographic region, country, city, etc. known for harboring hackers. In other embodiments, the threat identification module 202 identifies typical communication patterns, such as certain devices that communicate with a node 104 on a regular basis, geographic locations of devices communicating with the node 104 under normal circumstances, and then detects unusual communications, which may be from a threat device 112. In other embodiments, the threat identification module 202 identifies a potential threat based on particular types of communications, such as a failed login attempt, information in a message indicative of a virus, a phishing attempt, an attempt to gain access to a node 104, a high number of communications from a particular device, which may be a threat device 112, or the like.

In some embodiments, the threat identification module 202 identifies a potential security threat based on analysis of events happening at a node 104. For example, the threat identification module 202 may identify a login failure and may analyze the login failure to determine if the login failure is suspicious. In other embodiments, the threat identification module 202 identifies a potential security threat based on outgoing communications, such as a high volume of communications differing from typical communication volume, addresses of outgoing communications, or other situation where a node 104 is being used by a hacker to launch cyber attacks, viruses, phishing emails, etc. In some embodiments, the threat identification module 202 identifies a potential security threat based on commands being executed that are non-typical, such as deleting files, encrypting files, etc., which may be indicative of a ransomware attack, a virus, etc. One of skill in the art will recognize other operations, communications, interactions, etc. that are indicative of a potential security threat.

The apparatus 200 includes a threat communication module 204 configured to receive, at the first node 104a, a security communication from one or more other nodes 104b-104n, 106 of the peer group. Each security communication indicates that the node (e.g., 104b) of the peer group sending the security communication has identified a potential security threat similar to the potential security threat identified by the first node 104a.

For example, the first node 104a may have identified a login attempt from a location that is suspicious. The suspicious location may be from location where a user of the first node 104a does not normally communicate, from a country known for a lot of hackers, etc. The threat communication module 204 on the first node 104a may then receive security communications from other nodes 104b-104n of the peer group regarding login attempts from the same location, from a same IP address, from a same user, etc., which could be used to identify that the potential security threats identified by each node 104 are related to each other.

In some embodiments, each node 104 of the peer group transmits security communications to other nodes 104 of the peer group. The security communications, in some embodiments, include potential security threat information regarding potential security threats identified by the threat identification module 202 of the node 104 sending the security communication. In some embodiments, each node 104 of the peer group transmits security communications that involve information other than potential security threats, such as normal operations, indications that a potential security threat has been resolved, information about operations after actions have been taken based on a security threat, etc., which allows the threat detection and response apparatus 102 to distinguish between normal operations and operations indicative of a potential security threat, for example, using machine learning.

The apparatus 200 includes a consensus module 206 configured to reach a consensus with the other nodes 104 of the peer group that sent a security communication regarding the identified potential security threats that are similar. In some embodiments, the consensus module 206 is configured to analyze the potential security threat identified by the threat identification module 202 and the potential security threats in the security communications to determine if the potential security threats are similar. In some examples, the consensus module 206 uses information such as a common type of threat, a common sender, common identifying information in potential security threats, and the like to determine that the potential security threats are similar. In some embodiments, the consensus module 206 gleans through numerous security communications and potential security threats to identify a pattern, a common link, a common identifier, etc. to identify a common potential security threat from the threat identification module 202 and security communications.

The consensus module 206 is configured to use a consensus algorithm to determine that the nodes 104 in the peer group have reached a consensus. In some embodiments, the consensus module 206 determines that the nodes 104 in the peer group have reached a consensus based on a total number of nodes 104 in the peer group. In other embodiments, the consensus module 206 determines that the nodes 104 in the peer group have reached a consensus based on a number of nodes 104 in the peer group that have sent a security communication with a similar potential threat. In other embodiments, the consensus module 206 determines that the nodes 104 in the peer group have reached a consensus based on a percentage of nodes 104 in the peer group or a number of nodes 104 in the peer group sending a security communication with the similar potential security threat. One of skill in the art will recognize other ways for the consensus module 206 to determine that the nodes 104 in the peer group have reached a consensus.

The apparatus 200 includes a corrective action module 208 configured to take a corrective action to neutralize the potential security threat at the first node 104a in response to the consensus module 206 reaching a consensus with the other nodes (all or a portion of nodes 104b-104n) of the peer group that sent a security communication regarding the identified potential security threats that are similar. The corrective action, in some embodiments, is an action that prevents a potential security threat from having an effect that is unwanted at the first node 104a. For example, the corrective action may be to block incoming communications from the threat device 112 when communications from the threat device 112 are deemed potential security threats. In other embodiments, the corrective action prevents login attempts from a particular location, from a particular user, from a particular device, such as the threat device 112, etc. In other examples, the corrective action quarantines suspect files, emails, links, etc. identified as a potential security threat.

In other embodiments, the corrective action is an action that halts damage being caused by a security threat. In some examples, the corrective action halts executing code, such as code erasing files, encrypting files, code sending out communications, or other executing malicious code. In other embodiments, the corrective action restores files, code, etc. to a prior state. For example, the corrective action may roll back an operating system to a previous restore point. One of skill in the art will recognize other corrective actions to neutralize the potential security threat at the first node 104a. While the corrective action module 208 is directed to the first node 104a, any of the nodes 104 of the peer group may be a first node and the corrective action module 208 is configured to take corrective action on any node 104 on which the consensus module 206 resides.

FIG. 3 is a schematic block diagram illustrating another apparatus 300 for threat intelligence and log data analysis across clustered devices, according to various embodiments. The apparatus 300 includes a threat detection and response apparatus 102 with a threat identification module 202, a threat communication module 204, a consensus module 206, and a corrective action module 208, which are substantially similar to those described above in relation to the apparatus 200 of FIG. 2. In various embodiments, the apparatus includes a seed module 302, a machine learning algorithm 304, a security receiver module 308, a security transmitter module 310, a threshold module 306, and/or a consensus action module 312, which are described below. In some embodiments, the apparatus 300 is implemented with code stored on one or more computer readable storage media and the code is executable by a processor, which may be in a server, a desktop computer, etc. In other embodiments, the apparatus 300 is implemented with a programmable hardware device, such as an FPGA, a PAL, etc., which may be in a router 106, etc. In some embodiments, a portion of the apparatus 300 may be implemented with hardware circuits.

In some embodiments, the threat identification module 202 of the apparatus 300 includes a seed module 302 that includes examples of normal operations and examples of operations indicative of a security threat and the threat identification module 202 identifying the potential security threat includes determining that operations at the first node 104a resemble operations indicative of a potential security threat. The threat identification module 202 is configured to use seed from the seed module 302 information about various normal operations to compare with operations indicative of a potential security threat to apply to current operations at the first node 104a to determine when the current operations constitute a potential security threat.

In some examples, the seed module 302 includes a list of known good contacts, of contacts with which a user of the first node 104a communicates, etc. and/or contacts of known threat devices 112, regions, cities, locations, etc. known to harbor cyber attackers, etc. to help identify potential security threats. In some examples, the seed module 302 includes communication formats, contents, etc. indicative of normal communications as well as communication formats, contents, etc. that are examples of communications of known potential security threats to help determine potential security threats. One of skill in the art will recognize other examples of normal operations and examples of operations indicative of a potential security threat.

In some embodiments, the seed module 302 adds to an initial list of normal operations, contacts, etc. and the list of operations indicative of a security threat over time as potential security threats occur as well as other normal operations occur. For example, a list of known good contacts may increase over time as a user communicates with others. The threat identification module 202 may classify communications as normal, in some embodiments, as the user has conversations, regularly communicates, etc.

The threat identification module 202 of the apparatus 300 incudes, in some embodiments, a machine learning algorithm 304 configured to determine that operations of the first node 104a are a potential security threat. In some embodiments, the machine learning algorithm 304 uses information from the seed module 302 as input along with current operations to determine that the operations of the first know 104a are a potential security threat. Often a potential security threat is not identical to previous potential security threats and the machine learning algorithm 304 looks for trends, characteristics, etc. of a new potential security threat along with information from the seed module 302 to help identify similarities with either normal operations or operations indicative of a security threat.

For example, the machine learning algorithm 304 may identify certain patterns within content of communications from a threat device 112 that are stored by the seed module 302 and then may correlate the patterns with a current potential security threat to determine that the current potential security threat is an actual security threat. The machine learning algorithm 304, in some embodiments, uses initial seed information from the seed module 302 along with other operations that have been classified as normal or indicative of a potential security threat to determine if a current potential security threat is an actual security threat. The machine learning algorithm 304, in various embodiments, uses input that includes incoming communications to the first node 104a, operations within the first node 104a, outgoing communications from the first node 104a, and the like to determine whether a current potential security threat is an actual security threat.

In some embodiments, consensus module 206 of the apparatus 300 includes a threshold module 306 configured to determine that there is a consensus of the first node 104a and some or all of the other nodes 104b-104n have reached a consensus by determining that a number of the nodes 104 of the peer group that have identified the similar potential security threats exceeds a threat threshold. In some embodiments, the threat threshold is a static threshold. In some examples, the static threat threshold is based on the number of nodes 104 in the peer group. In other embodiments, the threshold module 306 sets the threat threshold based on a percentage of nodes 104 of the peer group, such as 75% of the nodes 104 in the peer group.

In other embodiments, the threat threshold is dynamic and the threshold module 306 changes the threat threshold based on a type for the potential security threat. For example, some types of security threats may have a lower threat threshold than other types of potential security threats. In other embodiments, the threshold module 306 sets the threat threshold based on the number of nodes 104 in the peer group that have identified a potential security threat that is similar to the potential security threat identified by the first node 104a. In the embodiments, the threshold module 306, in some instances, uses a percentage of nodes 104 of the peer group that identified the potential security threat similar to the potential security threat identified by the first node 104a.

In other embodiments, the threat threshold is dynamic and the threshold module 306 changes the threat threshold based on a seriousness of the potential security threat. In various examples, some security threat types may be more serious than others, some accounts being accessed by a threat device 112 may be more sensitive than others, etc. In some embodiments, the threshold module 306 changes the threat threshold based on timing of receipt of the potential security threat by the nodes of the peer group. For example, receiving security communications with a similar potential security threat in a short amount of time may indicate an immediate need due to an ongoing attack and the threshold module 306 may lower the threat threshold. One of skill in the art will recognize other ways for the threshold module 306 to dynamically adjust the threat threshold.

In some embodiments, the threat communication module 204 of the apparatus 300 includes a security receiver module 308 at the first node 104a configured to receive security communications from the other nodes 104b-104n of the peer group indicating that a threat identification module 202 of the other nodes 104b-104n have identified a potential security threat. The threat communication module 204 of the apparatus 300 includes, in other embodiments, a security transmitter module 310 configured to transmit a security communication from the first node 104a to each of the other nodes 104b-104n of the peer group. The security communication indicates that the threat identification module 202 of the first node 104a identified the potential security threat.

In some embodiments, the nodes 104, 106 of the peer group transmit and receive security communications over the private computer network 108. In other embodiments, the nodes 104, 106 of the peer group transmit and receive security communications over a management network separate from the private network 108. In other embodiments, the nodes 104, 106 of the peer group transmit and receive security communications over a public network 110.

In some embodiments, the security transmitter module 310 of each node 104, 106 of the peer group shares with each node of the other nodes 104, 106 of the peer group security communications relevant to determining potential security threats present at the node 104, security communications relevant to determining that potential security threats are not present at the node 104, and/or potential corrective actions. In other embodiments, the security transmitter module 310 transmits, from the first node 104a, a corrective action taken to neutralize a potential security threat to the other nodes 104b-104n of the peer group. The other nodes 104b-104n in the peer group that have identified a potential security threat similar to the potential security threat identified by the first node 104a take the corrective action received from the first node 104a.

In some embodiments, the first node 104a receives, through the security receiver module 308, potential corrective actions from other nodes 104b-104n of the peer group. In some embodiments, the apparatus 310 includes a consensus action module 312 configured to reach a consensus with the other nodes 104b-104n of the peer group on a consensus corrective action to be taken by the first node 104a and the other nodes 104b-104n of the peer group. The correction action module 208 then takes the consensus corrective action. While some embodiments include the nodes 104 of the peer group all taking the consensus corrective action, each node 104 may take a corrective action appropriate for that particular node 104. For example, a node (e.g. the router 106) with a firewall may block network traffic from a threat device 112 that is injecting malware into the private computer network 108 while endpoint nodes 104a-104n may configure antimalware to detect and quarantine the malware that was detected.

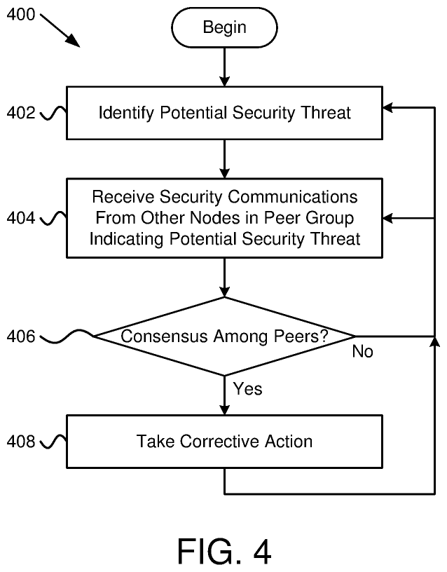

FIG. 4 is a schematic flow chart diagram illustrating a method 400 for threat intelligence and log data analysis across clustered devices, according to various embodiments. The method 400 begins and identifies 402, at a first node 104a in a network, a potential security threat. The first node 104a is one of a plurality of nodes 104 in a peer group. Each node 104 in the peer group has a level of trust for each node 104 in the peer group.

The method 400 receives 404, at the first node 104a, a security communication from one or more other nodes 104b-104n of the peer group. Each security communication indicates that the node (e.g., 104b) of the peer group sending the security communication has identified a potential security threat similar to the potential security threat identified by the first node 104a. The method 400 determines 406 if the first node 104a has reached a consensus with the other nodes 104b-104n of the peer group that sent a security communication regarding the identified potential security threats that are similar.

If the method 400 determines 406 that a consensus has not been reached, the method 400 returns and identifies 402 a potential security threat and/or receives 404 additional security communications. If the method 400 determines 406 that the first node 104a has reached a consensus with the other nodes 104b-104n, the method 400 takes 408 corrective action and returns and identifies 402 a potential security threat and/or receives 404 additional security communications. In various embodiments, all or a portion of the method 400 is implemented using the threat identification module 202, the threat communication module 204, the consensus module 206, and/or the corrective action module 208.

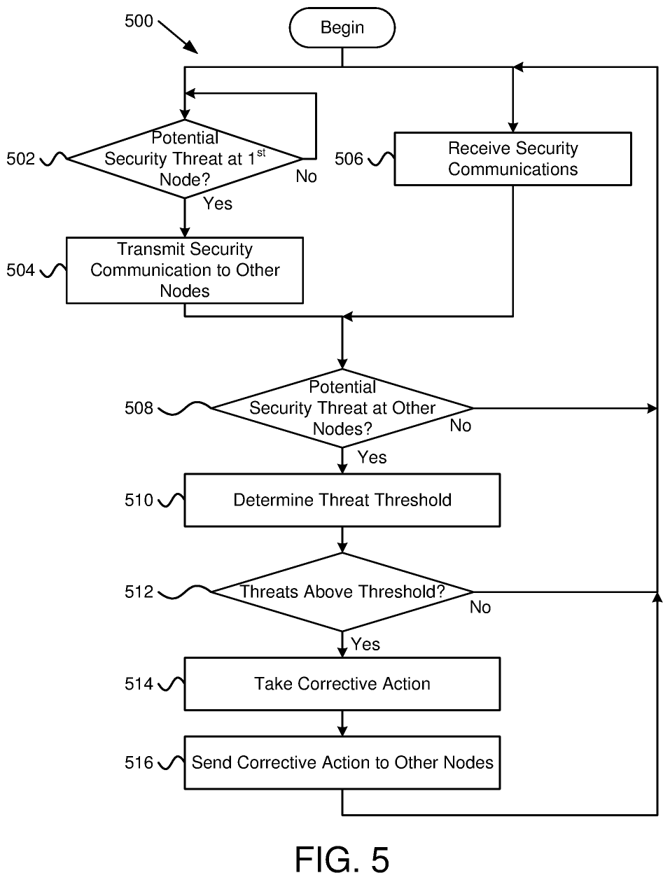

FIG. 5 is a schematic flow chart diagram illustrating another method 500 for threat intelligence and log data analysis across clustered devices, according to various embodiments. The method 500 begins and determines 502 if there is a potential security threat at the first node 104a. The first node 104a is one of a plurality of nodes 104 in a peer group and each node 104 in the peer group has a level of trust for each node 104 in the peer group. If the method 500 determines 502 that there is not a potential security threat, the method 500 continues to determine 502 if there is a potential security threat at the first node 104a. If the method 500 determines 502, at the first node 104a, that there is a potential security threat, the method 500 transmits 504, from the first node 104a, a security communication to the other nodes 104b-104n of the peer group with information about the potential security threat identified at the first node 104a.

While the method 500 is determining 502 if there is a potential security threat at the first node 104a, the method 500 simultaneously receives 506 security communications from other nodes 104b-104n of the peer group and determines 508 if there are any potential security threats in security communications received 506 from other nodes 104b-104n of the peer group that are similar to the potential security threat identified at the first node 104a. If the method 500 determines 508 that there are no similar potential security threats from received security communications, the method 500 continues to determine 502, at the first node 104a, if there are potential security threats and to receive 506 security communications and the to determine 508 if a received security threat is similar to a potential security threat at the first node 104a.

The method 500 determines 510, based on the potential security threats that are similar, a threat threshold. For example, the method 500 may have different threat thresholds for different types of security threats, different frequencies of security threats, different numbers of nodes 104 receiving similar potential security threats, etc. The method 500 determines 512 if the number of potential security threats at the nodes 104 that are similar are above a threat threshold. If the method 500 determines 512 that the number of potential security threats at the nodes 104 is not above the threat threshold, the method 500 returns and continues to determine 502, at the first node 104a, if there are potential security threats and to receive 506 security communications and the to determine 508 if a received security threat is similar to a potential security threat at the first node 104a.

If the method 500 determines 512 that that the number of potential security threats at the nodes 104 is above the threat threshold, the method 500 takes 514 corrective action and sends 516 the corrective action to the other nodes 104b-104n in a security communication and returns and continues to determine 502, at the first node 104a, if there are potential security threats and to receive 506 security communications and the to determine 508 if a received security threat is similar to a potential security threat at the first node 104a. In some embodiments, the corrective action is determined at the first node 104a. In other embodiments, the corrective action is based on a consensus of the nodes 104 of the peer group and carried out at each node 104 where the potential security threat exists. In various embodiments, all or a portion of the method 500 is implemented using the threat identification module 202, the threat communication module 204, the consensus module 206, the corrective action module 208, the threshold module 306, the security receiver module 308, the security transmitter module 310, and/or the consensus action module 312.

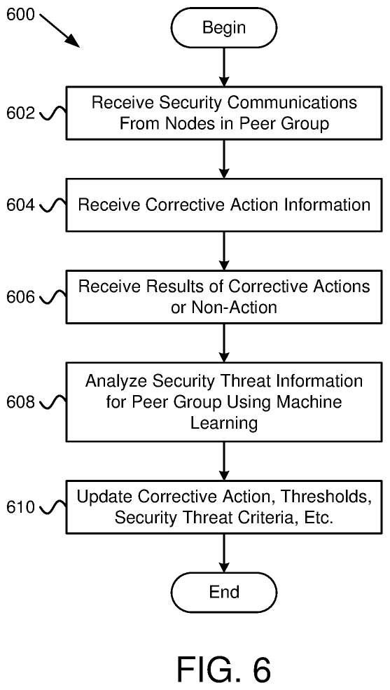

FIG. 6 is a schematic flow chart diagram illustrating another method 600 for analyzing threat intelligence and log data analysis across clustered devices using machine learning, according to various embodiments. The method 600 begins and receives 602 security communications from nodes 104 in a peer group and receives 604 corrective actions taken by the nodes 104 in the peer group. The method 600 receives 606 results of corrective actions or non-actions of the nodes 104 responding to security threats and analyzes 608 security threat information for the peer group using a machine learning algorithm 304. The security threat information includes received potential security threats, corrective action information, results of corrective actions or non-action, operating parameters of the nodes 104, and the like.

Based on results from the machine learning algorithm 304, the method 600 updates 610 corrective actions, threat thresholds, security threat criteria, and the like. The method 600 continually receives new security threat information and updates 610 the corrective actions, threat thresholds, security threat criteria, etc. In various embodiments, all or a portion of the method 600 is implemented using the threat identification module 202, the threat communication module 204, the consensus module 206, the corrective action module 208, the seed module 302, the machine learning algorithm 304, the threshold module 306, the security receiver module 308, the security transmitter module 310, and/or the connection action module 312.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
identifying, at a first node in a network, a potential security threat, the first node comprising one of a plurality of nodes in a peer group, wherein each node in the peer group has a level of trust for each node in the peer group;
receiving, at the first node, a security communication from one or more other nodes of the peer group, each security communication indicating that the node of the peer group sending the security communication has identified a potential security threat similar to the potential security threat identified by the first node; and
taking a corrective action to neutralize the potential security threat at the first node in response to reaching a consensus with the other nodes of the peer group that sent a security communication regarding the identified potential security threats that are similar.

2. The method of claim 1, wherein the first node comprises examples of normal operations and examples of operations indicative of a security threat and wherein identifying the potential security threat comprises determining that operations at the first node resemble operations indicative of a potential security threat.

3. The method of claim 2, wherein the potential security threat differs from the examples of normal operations.

4. The method of claim 2, wherein determining that the operations comprise a potential security threat comprises using machine learning seeded with the examples of normal operations and examples of operations indicative of a security threat and/or additional learning based on previous operations to determine that the operations comprise a potential security threat.

5. The method of claim 1, wherein reaching a consensus with the other nodes of the peer group that sent a security communication regarding the identified potential security threats that are similar comprises determining that a number of the nodes of the peer group that have identified the similar potential security threats exceeds a threat threshold.

6. The method of claim 5, wherein the threat threshold is dynamic and changes based on:
a type for the potential security threat;
a number of nodes in the peer group that have identified a potential security threat that is similar to the potential security threat identified by the first node;
a seriousness of the potential security threat; and/or
timing of receipt of the potential security threat by the nodes of the peer group.

7. The method of claim 1, further comprising transmitting a security communication from the first node to each of the other nodes of the peer group, the security communication indicating that the first node identified the potential security threat.

8. The method of claim 1, wherein each node of the peer group shares with each node of the peer group security communications relevant to determining potential security threats present at the node and/or security communications relevant to determining that potential security threats are not present at the node.

9. The method of claim 1, further comprising transmitting, from the first node, the corrective action to neutralize the potential security threat to the other nodes of the peer group.

10. The method of claim 9, wherein the other nodes in the peer group that have identified a potential security threat similar to the potential security threat identified by the first node take the corrective action received from the first node.

11. The method of claim 1, further comprising:
receiving, at the first node, potential corrective actions from other nodes of the peer group; and
reaching a consensus with the other nodes of the peer group on a consensus corrective action to be taken by the first node and the other nodes of the peer group,
wherein taking corrective action at the first node comprises taking corrective action based on the consensus corrective action.

12. The method of claim 1, wherein identifying a potential security threat comprises:
identifying a potential security threat from received network communications;
identifying a local authentication failure;
identifying local malicious event patterns; and/or
identifying indicators of a ransomware attack.

13. An apparatus comprising:
a processor; and
non-transitory computer readable storage media storing code, the code being executable by the processor to perform operations comprising:
identifying, at a first node in a network, a potential security threat, the first node comprising one of a plurality of nodes in a peer group, wherein each node in the peer group has a level of trust for each node in the peer group;
receiving, at the first node, a security communication from one or more other nodes of the peer group, each security communication indicating that the node of the peer group sending the security communication has identified a security threat potential security threat similar to the potential security threat identified by the first node; and
taking a corrective action to neutralize the potential security threat at the first node in response to reaching a consensus with the other nodes of the peer group that sent a security communication regarding the identified potential security threats that are similar.

14. The apparatus of claim 13, wherein the first node comprises examples of normal operations and examples of operations indicative of a security threat and wherein identifying the potential security threat comprises determining that operations at the first node resemble operations indicative of a potential security threat.

15. The apparatus of claim 14, wherein determining that the operations comprise a potential security threat comprises using machine learning seeded with the examples of normal operations and examples of operations indicative of a security threat and/or additional learning based on previous operations to determine that the operations comprise a potential security threat.

16. The apparatus of claim 13, wherein reaching a consensus with the other nodes of the peer group that sent a security communication regarding the identified potential security threats that are similar comprises determining that a number of the nodes of the peer group that have identified the similar potential security threats exceeds a threat threshold.

17. The apparatus of claim 16, wherein the threat threshold is dynamic and changes based on:
a type for the potential security threat;
a number of nodes in the peer group that have identified a potential security threat that is similar to the potential security threat identified by the first node;
a seriousness of the potential security threat; and/or
timing of receipt of the potential security threat by the nodes of the peer group.

18. The apparatus of claim 13, wherein:
each node of the peer group shares with each of the other nodes of the peer group security communications relevant to determining potential security threats present at the node, security communications relevant to determining that potential security threats are not present at the node, and/or potential corrective actions;
further comprising transmitting, from the first node, the corrective action to neutralize the potential security threat to the other nodes of the peer group, wherein the other nodes in the peer group that have identified a potential security threat similar to the potential security threat identified by the first node take the corrective action received from the first node; and/or
further comprising reaching a consensus with the other nodes of the peer group on a consensus corrective action to be taken by the first node and the other nodes of the peer group, wherein taking corrective action at the first node comprises taking corrective action based on the consensus corrective action.

19. A program product comprising a non-transitory computer readable storage medium storing code, the code being configured to be executable by a processor to perform operations comprising:
identifying, at a first node in a network, a potential security threat, the first node comprising one of a plurality of nodes in a peer group, wherein each node in the peer group has a level of trust for each node in the peer group;
receiving, at the first node, a security communication from one or more other nodes of the peer group, each security communication indicating that the node of the peer group sending the security communication has identified a potential security threat similar to the potential security threat identified by the first node; and
taking a corrective action to neutralize the potential security threat at the first node in response to reaching a consensus with the other nodes of the peer group that sent a security communication regarding the identified potential security threats that are similar.

20. The program product of claim 19, the operations further comprising:
transmitting a security communication from the first node to each of the other nodes of the peer group, the security communication indicating that the first node identified the potential security threat; and
transmitting, from the first node, the corrective action to neutralize the potential security threat to the other nodes of the peer group.
